(19) United States
(12) Patent Application Publication
(10) Pub. No.: US 2013/0129861 A1
(43) Pub. Date: May 23, 2013

(54) PEARLESCENT PIGMENT SURFACE TREATMENT FOR CHEWABLE CONFECTIONERY AND METHODS OF MAKING THE SAME

(71) Applicants: Juan Pablo Campomanes Marin, Puebla (MX); Kristen Schmitz, Jersey City, NJ (US); Aditi Shetty, Morris Plains, NJ (US)

(72) Inventors: Juan Pablo Campomanes Marin, Puebla (MX); Kristen Schmitz, Jersey City, NJ (US); Aditi Shetty, Morris Plains, NJ (US)

(21) Appl. No.: 13/806,353

(22) PCT Filed: Jun. 28, 2011
(86) PCT No.: PCT/US11/42158

§ 371 Date: Feb. 1, 2013

Related U.S. Application Data
(60) Provisional application No. 61/359,013, filed on Jun. 28, 2010.

(51) Int. Cl. A23G 4/06

(52) U.S. Cl. CPC A23G 4/062
USPC 426/5; 426/540

(57) ABSTRACT

Disclosed herein are particulate coating compositions comprising a powdered carrier and a pearlescent pigment. Also disclosed herein are pearlescent, coated chewing gum compositions comprising the particulate coating composition and methods for making the pearlescent coated chewing gum compositions.

### FIELD

This disclosure relates to particulate coating compositions that include pearlescent pigments and which provide a pearlescent appearance when applied to the surface of confectionery compositions. More particularly, the present disclosure relates to coated chewing gum compositions having a particulate pearlescent coating and methods for making the pearlescent coated chewing gum.

### BACKGROUND

Coatings are included on confectionery compositions for a variety of purposes including providing a color or texture, for providing a flavor, for protection of the core, for providing visual effects, and the like.

Pearlescent pigments are increasingly being used to provide enhanced visual effects to confectionery products. However the application and use of pearlescent pigments to provide visual effects on the surface of chewable confectionery or chewing gum, has proven to be difficult. Commercially available liquid coating compositions including pearlescent pigments, often include ethanol as a solvent. Such products cannot be used to coat the surface of chewing gum as the ethanol in the liquid coating causes the chewing gum to break apart and lose its structural integrity. Direct application of powdered pearlescent pigment to the surface of a chewing gum core is also difficult, as the powdered pigment does not naturally adhere to the gum surface. Further, when the pearlescent pigment is mixed with the chewing gum composition, the visual effect of the pearlescent pigment is not observed on the surface of the chewing gum.

There thus remains a need in the art for chewing gum and chewable confectionery products which have the visual appeal of pearlescent pigments. There also remains a need in the art for methods of coating chewing gum compositions that allow the pearlescent pigments to effectively adhere to the outer surface of the chewing gum yet do not cause the chewing gum core to break apart.

### SUMMARY

In one embodiment, a particulate coating composition comprises a powdered carrier and a pearlescent pigment.

In another embodiment, a coated chewing gum composition comprises a gum core comprising a gum base, and a particulate coating composition at least partially surrounding the gum core; wherein the particulate coating composition comprises a powdered carrier and a pearlescent pigment.

In another embodiment, a method of making a coated chewing gum comprises applying a particulate coating composition to at least one surface of a chewing gum core to form a coated chewing gum core, wherein the particulate coating composition comprises a pearlescent pigment. In yet another embodiment, the particulate coating composition further comprises a powdered carrier.

The above described and other features are exemplified by the following detailed description.

### DETAILED DESCRIPTION

When particulate pearlescent pigments are directly applied to the outer surfaces of chewing gum compositions, very little of the pearlescent pigment adheres to the chewing gum surface. The inventors have surprisingly found that powdered pearlescent pigments can be effectively applied to a surface of chewing gum when combined with a powdered carrier. Embodiments described herein pertain to particulate coating compositions comprising a powdered carrier and a pearlescent pigment. The resulting coated chewing gum compositions display a pearlescent surface that is visually appealing.

In addition to chewing gum, the particulate coatings can be also used to provide a pearlescent surface to a wide variety of confectionery cores including, but not limited to, a chewing gum, a center-filled confectionery, a chewable confectionery, a crunchy confectionery, a low boiled confectionery, a hard boiled confectionery, a fondant, a caramel, a jelly, a gummy, a nougat, an edible film, a nut paste, chocolate, fudge, or a combination comprising at least one of the foregoing confectionery cores.

The terms “coating” or “coating region” are used to refer to a region of a material that at least partially surrounds the confectionery core. Particulate coatings may be referred to as “sanding” compositions or “dusting” compositions. Confections with such particulate coatings may be referred to as sanded or dusted.

The terms “surround”, “surrounding”, “at least partially surrounding”, and the like are not limited to encircling. These terms can refer to enclosing or confining on all sides, encircling or enveloping, and are not limited to symmetrical or identical thicknesses.

The term “substantially covers” refers to coating compositions that covers more than 50% of the surface area of a chewing gum core. In other embodiments, “substantially covers” may refer to coverage that is more than 55%, more than 60%, more than 65%, more than 70%, more than 75%, more than 80%, more than 85%, more than 90%, more than 95%, more than 98%, and more than 99% of the surface are of a chewing gum core.

The particulate coating composition described herein is designed to provide pearlescence to a surface of a chewing gum core. The term “pearlescent pigment” refers to materials that exhibit a spectrum of colors resulting from light refraction instead of pigmentation where color results from light absorption. These pearlescent pigments exhibit colors depending upon the angles of illumination. A pearlescent pigment material generally creates a glossy finish appearance rather than a matte finish. In one embodiment, the presence of a pearlescent pigment in the particulate coating composition confers the ability to impart pearlescence to surfaces treated with the particulate coating composition.

The pearlescent pigments used in the particulate coating composition are based on the formation of inorganic layers, or coatings, on substrates such as glass or potassium aluminum silicate (also known as mica) through the process of calcination. Examples of inorganic materials that may be used to form the inorganic layers include metal oxides such as titanium dioxide, iron oxide and combinations comprising at least one of the foregoing metal oxides. The substrate may be coated with one or more layers of the metal oxide. In one embodiment, the pearlescent pigment used in the particulate coating composition comprises at least one layer of titanium dioxide deposited on mica platelets.

In some embodiments, the particles of the pearlescent pigment can be sized to a particular size for use in a particulate coating composition. That is, the particle size of the pearlescent pigment can be selected depending upon the desired visual effect to be attained. In one embodiment, pearlescent pigments with an average particle size of less than 15 micrometers (μm) in diameter can create a silky-looking appearance. In another embodiment, pearlescent pigments with average particle size of about 5 μm to about 25 μm can create a satin-looking appearance. In yet another embodiment, pearlescent pigments with an average particle size from about 10 μm to about 60 μm can create a metallic-looking appearance. In a further embodiment, pearlescent pigments with an average particle of about 10 μm to about 250 μm can create a glitter-looking appearance. Average particle sizes can be measured by any suitable methods known in the art. Specifically, particle size can be determined based upon sieve analysis using a standardized mesh series of screens.

Pearlescent pigments can include materials such as those described in U.S. Patent Publication No. 2007/0014321 and U.S. Patent Publication No. 2008/0014321. Pearlescent pigments are commercially available under a number of trade names including SensiPearl™, Candurin™, and Edible Glitter™ (edible glitter). Pearlescent pigments such as those under the trade name of Candurin™ may provide a wide range of color effects including, for example, silver fine, silver sheen, silver luster, silver sparkle, gold shimmer, red shimmer, blue shimmer, green shimmer, gold sheen, light gold, gold luster, brown amber, orange amber, red amber, red luster and red sparkle.

Pearlescent pigments can further include natural and/or artificial food colors. Exemplary food colors considered to be natural can include, but are not limited to, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), indigo carmine, carmoisine/azorubine (E122), sodium copper chlorophyllin (E141), chlorophyll (E140), chlorophyllin, copper chlorophyllin, copper chlorophyll, curcumin/copper chlorophyllin, toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot, carrot oil, corn endosperm oil, paprika, paprika oleoresin, paprika extract, phaffia yeast, riboflavin (E101), saffron, turmeric (E100), turmeric oleoresin, tumeric root, amaranth (E123), capsanthin/capsorbin (E160c), lycopene (E160d), black carrot, black carrot extract, elderberry, aronia, allura red, curcumin, spinach, stinging nettle, burnt sugar, carbo medicinalis, and a combination comprising at least one of the foregoing food colors.

Food colors considered to be artificial can include but are not limited to, certified colors such as FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), brilliant blue FCF, titanium dioxide (E171), aluminium (E173), allura red, silver (E174), gold (E175), pigment rubine/lithol rubine BK (E180), calcium carbonate (E170), carbon black (E153), black PN/brilliant black BN (E151), brown HT, green S, green S/acid brilliant green BS (E142), and a combination comprising at least one of the foregoing food colors. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

In one embodiment, the pearlescent pigment can be in the form of a powdered pearlescent pigment. As used herein, the term “powdered pearlescent pigment” and “particulate pearlescent pigment” are used interchangeably and refer to a pearlescent pigment in particulate form, e.g. without a fluid carrier. In one embodiment, the pigmented coating composition comprises a powdered carrier and a powdered pearlescent pigment.

In another embodiment, the pearlescent pigment can be in the form of a flaked film comprising the pearlescent pigment. The flaked film comprising the pearlescent pigment may be prepared by the comminution of edible films comprising suitable film-forming materials and particles of the pearlescent pigment. For example, flaked films may include those commercially available from Watson Foods as edible glitter. Any film-forming material known in the art is suitable for preparing the flaked films. Examples of film forming materials include those selected from the group consisting of gum arabic, pullulan, starch, maltodextrins, pectin, hydroxypropylmethylcellulose, alginates, carageenans, and a combination comprising at least one of the foregoing film forming materials. The flaked films can have a length or width from about 4760 μm to about 590 μm (about 4 to about 30 mesh), specifically, about 2380 μm (about 8 mesh), but is not limited thereto. Additional ingredients, such as flavors and/or sweeteners can also be included in the flaked films. In one embodiment, the pigmented coating composition comprises a powdered carrier and a flaked film comprising a pearlescent pigment.

The amount of pearlescent pigment present in the particulate coating composition is about 5% to about 60%, specifically about 10% to about 50%, more specifically about 15% to about 25% by weight based on the weight of the particulate coating composition. In one embodiment, the pearlescent pigment is present in the particulate coating composition in an amount of about 5%, about 10%, about 15%, about 20%, about 30%, about 40%, about 45%, about 50%, or about 55% by weight, based on the weight of the particulate coating composition.

The powdered carrier in the particulate coating composition is not particularly limited. As used herein, the term “powdered carrier” refers to a carrier in particulate form, e.g. without a fluid carrier. In some embodiments, the powdered carrier is selected from the group consisting of talc, mannitol, isomalt (hydrogenated isomaltulose), polyglycitol, lactitol, erythritol, sucrose and a combination comprising at least one of the foregoing powdered carriers. In one embodiment, the powdered carrier is talc or mannitol.

The particle size of the powdered carrier may have a size similar to or different than the particle size of the pearlescent pigment. In some embodiments, the powdered carrier has a particle size that is essentially the same as the particle size of the pearlescent pigment in order to provide improved stability to the particulate coating composition. In one embodiment, the powdered carrier and the pearlescent pigment have similar particle sizes such that when they are mixed together, they form a homogeneous blend. Specifically, the average particle size of the powdered carrier may be about 0.5 μm to about 500 μm, more specifically about 1 μm to about 300 μm, and more specifically about 5 μm to about 250 μm, but is not limited thereto. In other embodiments, the average particle size of the powdered carrier is selected to match the size of pores present at the surface of the chewing gum core. In such instances, matching the particle size of the powdered carrier to the gum pore size increases the possibility that the pearlescent pigment will be deposited more closely to the surface of the chewing gum core thereby enhancing any visual effects. For example, the selective deposition of the powdered carrier within the pores of the chewing gum core will effectively force the pearlescent pigment to the surface.

The amount of powdered carrier present in the particulate coating composition is about 40% to about 95%, specifically about 50% to about 90%, more specifically about 75% to about 85% by weight, based on the weight of the particulate coating composition. In one embodiment, the powdered carrier is present in the particulate coating composition in an amount of about 45%, about 50%, about 55%, about 60%, about 65%, about 70%, about 75%, about 80%, about 85%, about 90% or about 95% by weight, based on the weight of the particulate coating composition.

In some embodiments, the weight ratio of the powdered carrier to the pearlescent pigment in the particulate coating composition is about 40:60 to about 95:5. Specifically, in some embodiments the weight ratio of the powdered carrier to the pearlescent pigment is about 55:45 to about 90:10, more specifically about 85:15 to about 75:25. In one embodiment, the weight ratio of the powdered carrier to the pearlescent pigment is about 50:50 to about 85:15.

The particulate coating composition may be prepared by combining the powdered carrier with the pearlescent pigment (powdered or flaked films) and mixing the components together in an apparatus which is typically used to blend powders. Examples of such may include, a ribbon blender or a V blender, but are not limited thereto. The powdered carrier and pearlescent pigment are then mixed until they are well blended.

The particulate coating composition may optionally further include an additional ingredient such as those selected from the group consisting of a food acid or salt thereof, a sweetener, a sensate, a flavorant, a flavor modulator or potentiator, a functional ingredient, or a combination comprising at least one of the foregoing ingredients. In some embodiments, the ingredient is encapsulated or unencapsulated (or “free”), or a combination of encapsulated and unencapsulated ingredients. If more than one ingredient is used, the particulate coating composition may contain any combination of encapsulated or unencapsulated ingredients.

When used, the additional ingredient may be in particulate form and can have a size similar to, or different than, the powdered carrier or pearlescent pigment. In one embodiment, the various components of the particulate coating composition have similar particle sizes such that when they are mixed together, they form a homogeneous blend.

Disclosed herein are coated chewing gum compositions having a pearlescent surface. In some embodiments, the coated chewing gum comprises a gum core comprising a gum base, and a particulate coating composition at least partially surrounding the gum core; wherein the particulate coating composition comprises a powdered carrier and a pearlescent pigment.

As used herein, the terms “bubble gum” and “chewing gum” are used interchangeably and are both meant to include any gum composition.

The chewing gum core comprises a gum base, bulk sweeteners, high intensity sweeteners, flavorants, coloring agents, sensates, and any other optional additives, including throat-soothing agents, spices, tooth-whitening agents, breath-freshening agents, vitamins, minerals, caffeine, drugs (e.g., medications, herbs, and nutritional supplements), oral care products, and a combination comprising at least one of the foregoing additives.

As used herein, the terms “elastomeric portion” and “gum base” refer to water insoluble material(s) and can include, but are not limited to, elastomers, bulking agents, waxes, elastomer solvents, emulsifiers, plasticizers, fillers, and a combination comprising at least one of the foregoing materials.

The chewing gum core generally contains an elastomer. The elastomer may be present in a gum base which may further include a fat, an emulsifier, and optionally an additional gum base ingredient selected from the group consisting of a wax, a filler, an antioxidant, and a combination comprising at least one of the foregoing ingredients.

The amount of gum base employed will vary greatly depending upon various factors such as the type of base used, the desired consistency of the chewing gum, and the other components used in the composition to make the final chewing gum core. In general, the gum base will be present in amounts of about 5% to about 60% of the chewing gum core, specifically about 25% to about 50%, more specifically about 30% to about 45%, and yet more specifically about 35% to about 40% by weight, based on the weight of the chewing gum core.

Exemplary elastomers to be used in the chewing gum core include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like. Synthetic elastomers such as butadiene-styrene copolymers, polyisobutylene, isobutyleneisoprene copolymers, polyethylene, a combination comprising at least one of the foregoing elastomers, are also useful. The gum base can include a non-toxic vinyl polymer, such as polyvinyl acetate and its partial hydrolysate, polyvinyl alcohol, and a combination thereof. When utilized, the molecular weight of the vinyl polymer can range from about 3,000 up to and including about 94,000. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and a combination comprising at least one of the foregoing polymers.

In one embodiment, the elastomer is present in an amount of about 0.2% to about 15% by weight of the chewing gum core specifically about 3.0% to about 8.0% by weight of the chewing gum core.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and a combination comprising at least one of the foregoing plasticizers and softeners.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like can also be incorporated into the gum base to obtain a variety of desirable textures and consistency properties.

When a wax is present in the gum base, it softens the polymeric elastomer mixture and improves the elasticity of the gum base. The waxes employed will have a melting point below about 60° C., specifically about 45° C. to about 55° C. The low melting wax can be a paraffin wax. The wax can be present in the gum base in an amount of about 6% to about 10%, specifically about 7% to about 9.5% by weight, based on the weight of the gum base.

In addition to the low melting point waxes, waxes having a higher melting point can be used in the gum base in amounts of up to about 5% by weight of the gum base. Such high melting waxes include beeswax, vegetable wax, candelilla wax, carnauba wax, most petroleum waxes, and the like, and mixtures thereof.

The chewing gum core or gum base can optionally contain conventional elastomer solvents to aid in softening the elastomer base component, for example trepanned resins such as polymers of alpha-pinene or beta-pinene, methyl, glycerol or pentaerythritol esters of rosins or modified rosins and gums, such as hydrogenated, dimerized or polymerized rosins, and combinations comprising at least one of the foregoing resins, the pentaerythritol ester of partially hydrogenated wood or gum rosin, the pentaerythritol ester of wood or gum rosin, the glycerol ester of wood rosin, the glycerol ester of partially dimerized wood or gum rosin, the glycerol ester of polymerized wood or gum rosin, the glycerol ester of tall oil rosin, the glycerol ester of wood or gum rosin, the partially hydrogenated wood or gum rosin, the partially hydrogenated methyl ester of wood or rosin, and the like. The elastomer solvent can be used in amounts of about 5% to about 75%, and specifically about 45% to about 70% by weight, based on the weight of the gum base.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and a combination comprising at least one of the foregoing mineral adjuvants, which can serve as fillers and textural agents. These fillers or adjuvants can be used in the gum base in various amounts. Specifically the amount of filler, when used, will be present in an amount of greater than about 0% to about 60% by weight of the gum base, and more specifically from about 20% to about 30% by weight of the gum base.

Suitable emulsifiers include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and a combination thereof.

Additional components of the chewing gum core include a bulk sweetener, a softener system, a food acid, and a combination thereof. The chewing gum core may further comprise an ingredient selected from the group consisting of a high intensity sweetener, a sensate, a flavor, a color, a functional ingredient, an antioxidant, and a combination thereof.

The bulk sweetener for use in the chewing gum core can include sugar sweeteners, sugarless sweeteners and a combination thereof. Sugar sweeteners generally include saccharides. Suitable sugar sweeteners include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, and a combination thereof.

The sugarless sweetener can be a sugar polyol, specifically erythritol, galactitol, hydrogenated isomaltulose (isomalt), a hydrogenated starch hydrolysate, lactitol, maltitol, mannitol, polyglycitol, sorbitol, xylitol, or a combination comprising at least one of the foregoing polyols.

The bulk sweetener can be present in the chewing gum core in an amount of about 40% to about 60%, specifically about 45% to about 55%, and more specifically about 48% to about 53% by weight, based on the weight of the chewing gum core.

The chewing gum can further include a softener. Exemplary softeners include lanolin, palmitic acid, oleic acid, stearic acid, sodium stearate, potassium stearate, glyceryl triacetate, lecithin, glyceryl lecithin, glyceryl monostearate, propylene glycol monostearate, an acetylated monoglyceride, glycerine, a natural or synthetic wax, a hydrogenated vegetable oil, sorbitan monostearate, tallow, propylene glycol, and a combination thereof, specifically an acetylated monoglyceride, lecithin, glycerine, a hydrogenated starch hydrolysate (e.g., Lycasin 80/55), and a combination thereof.

The softener can be present in the chewing gum core in an amount of about 1% to about 5%, specifically about 1.5% to about 4%, and more specifically about 2% to about 3% by weight, based on the weight of the chewing gum core.

The food acid suitable for use in the chewing gum core include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and a combination thereof, specifically citric acid, malic acid, and a combination thereof.

The food acid can be present in the chewing gum core in an amount of about 0.01% to about 2.0%, specifically about 0.1% to about 1.5%, and more specifically about 0.3% to about 1.0% by weight, based on the weight of the chewing gum core.

The chewing gum core can further include a high intensity sweetener. Specific high intensity sweeteners for use in the chewing gum core include aspartame, neotame, sucralose, monatin, acesulfame potassium, an encapsulated form of the high intensity sweetener, or a combination comprising at least one of the foregoing high intensity sweeteners.

The amount of high intensity sweetener present in the chewing gum core can be about 2% to about 6%, specifically about 3% to about 5% by weight, based on the weight of the chewing gum core.

Flavorings that can be used in the chewing gum core include aldehydes and esters such as cinnamyl acetate, cinnamaldehyde, citral diethylacetal, dihydrocarvyl acetate, eugenyl formate, p-methylamisol, or a combination comprising at least one of the foregoing flavorings. Generally any flavoring or food additive such as those described in Chemicals Used in Food Processing, publication 1274, pages 63-258, by the National Academy of Sciences, may be used, which text is incorporated herein by reference.

The flavoring agents can be used in many distinct physical forms well known in the art to provide an initial burst of flavor and/or a prolonged sensation of flavor. Without being limited thereto, such physical forms include free forms, such as spray dried, powdered, and beaded forms, and encapsulated forms, or a combination comprising at least one of the foregoing physical forms.

The coloring agents are used in amounts effective to produce the desired color in the chewing gum core. These coloring agents include pigments, which may be incorporated in amounts up to about 6% by weight of the gum composition. An exemplary pigment, titanium dioxide, may be incorporated in amounts up to about 2%, and specifically less than about 1% by weight, based on the weight of the chewing gum core. The colorants can also include natural food colors and dyes suitable for food, drug and cosmetic applications. These colorants are known as F.D.&C. dyes and lakes. The materials acceptable for the foregoing uses are specifically water-soluble. A full recitation of all F.D.&C. colorants and their corresponding chemical structures may be found in the Kirk-Othmer Encyclopedia of Chemical Technology, 3rd Edition, in volume 5 at pages 857-885, which text is incorporated herein by reference.

The chewing gum core can further include a sensate selected from the group consisting of a cooling agent, a warming agent, a tingling agent, and a combination thereof.

The amount of flavor, sensate, and combination thereof present in the chewing gum core can be up to about 5.0%, specifically about 1.0% to about 4.0%, and more specifically about 2.0% to about 3.0% by weight, based on the weight of the chewing gum core.

The chewing gum core can further include a functional ingredient such as a breath freshener, a dental care component, an active, an herbal, an effervescing system, an appetite suppressor, a vitamin, a micronutrient, a mouth moistening component, a throat care component, an energy boosting agent, a concentration boosting agent, or a combination comprising at least one of the foregoing functional ingredients.

The chewing gum cores can be prepared using standard techniques and equipment. In one exemplary process, a gum base is heated to a temperature sufficiently high to soften the base without adversely effecting the physical and chemical make up of the base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, the bulking agent or sweeteners, the softener and coloring agents to plasticize the blend as well as to modulate the hardness, viscoelasticity and formability of the base, and the flavor enhancing composition (as a concentrate with other additives or separately). Mixing is continued until a uniform mixture of the gum composition is obtained. Thereafter the gum composition mixture can be formed into a desired shape.

The chewing gum cores can be provided in a variety of different forms, such as, for example, slabs, pellets, sticks cylinders, chunks ropes, strings, balls, cubes, candy gums, center-fill gums, multi-region gums, deposited gums and compressed gums.

The chewing gum core can be prepared using a batch method, a continuous method or a combination thereof. As used herein, “a continuous mixer” is processing equipment in which the various ingredients used to prepare a composition are fed substantially continuously into the device whilst those ingredients are being mixed and removed or ejected from the mixing apparatus. For example, in a continuous mixing extruder, some ingredients are substantially continuously introduced through various feed ports while others are introduced downstream, all the while the screws, blades or other mixing elements continuing to convey the mixture through the apparatus, all the while mixing the same. At a downstream portion of the extruder, the wholly or partly combined mass is ejected from the extruder by the force of the mass continually being conveyed and/or facilitated by an external pump.

The chewing gum core can also be a center-fill chewing gum composition. The center-fill chewing gum composition includes a center-fill composition and a chewing gum region. The chewing gum portion has a similar composition and mode of manufacture to that described above. The center-fill composition may be a liquid, such as an aqueous liquid or a gel, a powder or other solid, or a gas. Typically, the center fill composition is injected into the center of the gum during processing.

The center-fill composition can include any conventional filling or combination of filling materials. The center-fill may be sugar or sugar-free and it may contain fat or be fat-free. Additionally, the center-fill may contain vegetable-based, dairy-based or fruit-based materials such as, but not limited to, fruit juices, fruit concentrates, fruit purees, dried fruit materials, and the like. Further, in some embodiments, the center-fill component may include one or more sweeteners or additional ingredients such as those discussed above. The center-fill may also include one or more hydrocolloid materials. In some embodiments, the appearance of the center-fill composition is the same as the appearance of the chewing gum region. In other embodiments, the appearance of the center-fill composition is different than the appearance of the chewing gum region.

The center-fill chewing gum composition and other compositions described herein can be formed by any technique known in the art which includes the method described by U.S. Pat. No. 6,280,780 to Degady et al. which is herein incorporated by reference in its entirety. Degady describes an apparatus and method for forming center-filled gum pellets. The method includes first extruding a liquid-filled rope of a chewing gum layer and passing the rope through a sizing mechanism including a series of pairs of pulley-shaped roller members. The roller members “size” the rope or strand of gum material such that it leaves the series of rollers with the desired size and shape for entering a tablet-forming mechanism.

In one embodiment, the particulate coating composition at least partially surrounds the chewing gum core. In another embodiment, the particulate coating composition substantially covers the surface of the chewing gum core. In yet another embodiment, the particulate coating composition covers more than 55%, more than 60%, more than 65%, more than 70%, more than 75%, more than 80%, more than 85%, more than 90%, more than 95%, more than 98%, and more than 99% of the surface area of the chewing gum core. In an even further embodiment, the particulate coating composition covers 100% of the surface area of the chewing gum core.

In some embodiments, the particulate coating on the chewing gum core may be continuous or discontinuous. In some embodiments, the particulate coating may completely surround, coat, cover, or enclose the chewing gum core. In other embodiments, the particulate coating may only partially surround, coat, cover, or enclose the chewing gum core.

In some embodiments, the amount of particulate coating on the chewing gum core is about 0.5%, about 1.0%, about 2%, about 3.0%, about 4.0%, about 5%, about 6.0%, about 7%, about 8%, about 9%, about 10%, about 11%, about 12%, about 13%, about 14%, or 15% by weight, based on the weight of the coated chewing gum composition. In other embodiments, the amount of particulate coating on the chewing gum core is about 0.5% to about 20% by weight, specifically about 0.75% to about 15%, more specifically about 1% to about 10%, and even more specifically about 2% to about 8% by weight, based on the weight of the coated chewing gum composition.

In some embodiments, the particulate coating composition is applied to the surface of the chewing gum core in such a way as to create a pattern. Such patterns can be selected from the group consisting of a striped pattern, a swirled pattern or a random pattern, or any combination thereof. Suitable striped patterns can include those created by parallel, linear, or curvilinear lines. Suitable swirled patterns can include those created by non-parallel, curvilinear lines. Suitable random patterns can include any variety and/or shape of shaped objects such as, but not limited to, dots, stars, circles (open or closed), splotches, etc. Random patterns are generally considered to be those that do not provide a repeating series of objects. Combinations of patterns are also contemplated by the invention such as stripes with swirls, stripes with random objects, and swirls with random objects. Stripes and swirls created by random patterned objects are also contemplated.

Disclosed herein are methods of making a coated a chewing gum composition having a pearlescent surface. In one embodiment, the method comprises applying a particulate coating composition to at least one surface of a chewing gum core to form a coated chewing gum core. The applied particulate coating composition at least partially surrounds the chewing gum core.

In some embodiments, the method comprises subjecting at least one surface of the chewing gum core to a pretreatment step prior to applying the particulate coating composition. The pretreatment step effectively increases the adherence of the particulate coating composition to the surface(s) of the chewing gum core. That is, by subjecting the surface of the chewing gum core to the pretreatment step, the surface will adequately allow the particulate coating composition to adhere to the treated surface.

Pretreatment steps that effectively increase adherence of the particulate coating composition to the chewing gum core include application of heat to the at least one surface, application of an external substance or material to the at least one surface, or a combination comprising the application of both heat and an external substance to the at least one surface. The surface treatment may be applied to the whole or entire surface of the chewing gum core, or it may only be applied to certain surfaces of the chewing gum core. Following the pretreatment step, the particulate coating composition is applied to the pretreated surface(s) of the chewing gum core.

In some embodiments, the pretreatment step comprises application of an external substance or material to the at least one surface of the chewing gum core. For example, the application of a particulate coating to the exterior of a chewing gum core may be accomplished by pretreating a surface with moisture such as by steam treating the chewing gum core and then applying the particulate coating in a tumbling operation. In some embodiments,

the pretreatment step comprises wetting at least one surface of the chewing gum core through the application of a binding liquid (also referred to herein as a “binding syrup”) prior to application of the particulate coating. The binding liquid used to wet the at least one surface of the chewing gum core may be an aqueous binding liquid, a non-aqueous binding liquid, or a combination comprising at least one of the foregoing binding liquids.

In one embodiment, the method of making a coated chewing gum composition comprises applying an aqueous or non-aqueous binding liquid to at least one surface of the chewing gum core prior to applying the particulate coating composition. In another embodiment, the formed coated chewing gum composition comprises a binding layer disposed between the gum core and the particulate coating composition.

The binding liquid may be any desired aqueous or non-aqueous binding liquid. In one embodiment, the aqueous binding liquid comprises water and a binding agent selected from gum arabic, a cellulose, a starch, a sweetener such as a sugar polyol, a saccharide, (e.g. maltodextrin, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup), gelatin, or a combination comprising at least one of the foregoing binding agents.

In some embodiments, the binding agent is present in the binding liquid in an amount of about 10% to about 50%, specifically about 15 to about 45%, more specifically about 30% to about 40% based on the total amount of aqueous binding liquid.

In one embodiment, the aqueous binding liquid comprises water and gum arabic. Specifically, the aqueous binding liquid includes about 40% gum arabic and about 60% water. In another embodiment, the aqueous binding liquid comprises water and gelatin. Specifically, the aqueous binding liquid includes water and about 15% to about 20% of gelatin. In some embodiments, the gelatin has a bloom number of about 125 to about 250.

In one embodiment, the binding liquid is a non-aqueous binding liquid comprising fats, waxes, liquid oils or a combination comprising at least one of the foregoing components. Optionally, a combination of aqueous and non-aqueous solutions may be used in the surface treatment step. In one embodiment, the pearlescent pigment can be combined with the non-aqueous binding liquid and applied directly to the surface of the chewing gum core.

Other components can be optionally included in the binding liquid if desired, including, for example, color and flavors. The binding liquid may further comprise a food acid or food acid salt, an additional sweetener, a sensate, a flavorant, a flavor modulator or potentiator, a coloring agent, a functional ingredient, or a combination thereof.

Following application of the binding liquid to a desired surface or surfaces, the binding liquid may optionally be dried for a sufficient time and temperature. The binding liquid-coated confectionery can be dried for about 1 to about 60 seconds, specifically about 20 to about 40 seconds. The optional drying step aids in removing excess surface moisture while leaving the surface of the chewing gum core tacky. In some embodiments, the drying step may be omitted, thereby leaving more moisture present at the treated surface of the chewing gum core. The binding liquid may be an aqueous binding liquid or a non-aqueous binding liquid.

The binding liquid can be applied to a surface of the chewing gum core by any means desired. For example, the binding liquid can be sprayed onto the surface of the chewing gum core. In other embodiments, the binding liquid can be enrobed around the chewing gum core, or it can be painted onto the desired surface of the chewing gum core using either contact or non-contact methods. In other embodiments, the binding liquid can be applied to the surface of the chewing gum core by traditional panning methods. If desired, the binding liquid can be applied to the surface of the chewing gum core by dipping, or by screw conveying the chewing gum. If desired, the binding liquid can be applied to one or more surfaces of the composition in a pattern or in other specific locations. Thus, the binding liquid can be applied to the surface to create a symbol, letter, number, design or any desired pattern. A combination of the aforementioned methods of applying the binding liquid may be used, if desired.

In some embodiments, the pretreatment step includes heating at least one surface of the chewing gum core. The step of heating the surface of the chewing gum core may be conducted with or without the application of a binding liquid. For example, the surface or surfaces of the chewing gum core may first be subjected to heat, followed by the step of applying the particulate coating composition to the heated surface. Alternatively, a binding liquid may be applied to the desired surface or surfaces of the chewing gum core, either prior to heating or after heating the surface or surfaces of the chewing gum core.

The step of heating at the at least one surface of the chewing gum core can be accomplished by any desired means. For example, the step of heating at least one surface may include extruding the chewing gum composition via a heated extruder. In some heated extruder embodiments, the heating step can heat the chewing gum surface to temperatures of from about 18° C. to about 60° C. In one embodiment, the chewing gum surface is heated to from about 35° C. to about 50° C. In another embodiment, the chewing gum surface is heated to a temperature of about 50° C. In yet another embodiment, the step of heating the surface of the chewing gum composition includes applying localized heat to the desired surface or surfaces of the chewing gum composition. Any desired means to apply localized heat to the surface or surfaces of the chewing gum composition may be used. As with the application of binder solution, heat may be applied in any desired pattern, design, shape, or image. In some localized heating embodiments, the chewing gum composition surface is exposed to temperatures of about 70° C. to about 500° C. for a period of about 0.1 second to about 120 seconds. To avoid excessive melting or deformation of the chewing gum composition surface, there may be an inverse relationship between the temperature of the heat treatment and the time of exposure such that higher temperatures are used for shorter times.

Following the completion of the pretreatment step, the particulate coating composition is applied to the pretreated surface or surfaces of the chewing gum core. The particulate coating composition may be applied to the desired surface of the confectionery by any means desired, including panning, dipping, spraying, rolling, brushing, and a combination thereof. Optionally, after the step of applying the particulate coating composition has been completed, a further step of applying pressure to the coated surface may be used.

In some embodiments, the method of making a coated chewing gum comprises heating at least one surface of a chewing gum core and applying a particulate coating composition to the at least one surface. In one embodiment, the particulate coating composition comprises a pearlescent pigment. The inventors have surprisingly found that the pearlescent pigment may be directly applied to a surface(s) of a chewing gum core that has been pretreated by heating the at least one surface, without the need for the powdered carrier. Alternatively, a particulate coating composition including both the powdered carrier and the pearlescent pigment may be applied to the heated surface of the chewing gum core.

The optional step of forming the chewing gum into individual pieces prior to coating may be performed, if desired. In some embodiments, the particulate coating composition is applied to a surface of the chewing gum core after individual pieces of the chewing gum are formed while in other embodiments, the pigmented coating composition is applied to a surface of the chewing gum core before individual pieces of the chewing gum are formed. Any desired means to form the individual pieces may be used, including, but not limited to extrusion, rolling, scoring, rope cutting, casting, molding, and a combination thereof.

### Other Confectionery Cores

In other embodiments, the particulate coating composition may also be applied to confectionery cores other than chewing gum. In some embodiments, the confectionery core is a chewable confectionery including gummy candy or “gummi” confectionery. The chewable confectionery may include soft candies such as, but not limited to, gum drops, licorice, fruit snacks, starch based jellies, gelatin based jellies, pectin based jellies, carageenan based jellies, agar based jellies, konjac based jellies, starch candy, nougat, toffee, taffy, marshmallow, fondant, fudge, chocolate, marzipan, and jelly beans. The chewable confectionery may also include harder candies such as, but not limited to, compressed tablets, hard boiled candy, nut brittles, pastilles, pralines, dragees, and lozenges. The base of the chewable confectionery may be a sugar/glucose syrup combination or a polyol/polyol syrup combination and a gelatinizing agent, the latter of which may be gelatin, agar, gum arabic, maltodextrin, pectin, modified starches and combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

In general, preparation of a hard candy involves: mixing and heating, forming a melt a sugar polyol and optionally, other sugar polyols and/or a diluent such as water; cooking the melt; removing excess moisture from the melt; cooling the melt with mixing until the melt is a plastic-like, workable mass; while the melt is a plastic-like mass, incorporating optional ingredients; and forming the plastic-like mixture into a desired size and shape.

Methods known in the art of making hard confectionaries include those utilizing fire cookers, vacuum cookers, and scraped-surface cookers (aka high speed atmospheric cookers). In a suitable example of a method utilizing fire cookers, the desired quantity of the sugar polyol is dissolved in water by heating in a kettle until dissolved. Additional optional sugar polyols can be added and cooking continued until a final temperature of about 145-165° C. is achieved. The mix is then cooled, worked as a plastic-like mass, and admixed optional ingredients such as flavors, colorants, high-intensity sweeteners, and the like.

A suitable example of a method utilizing vacuum cookers, the sugar polyol components are boiled at a temperature of about 125-132° C., vacuum is applied and additional water is boiled off without extra heating. When cooking is complete, the mass is a semi-solid having a plastic-like consistency. Optional conventional additives are admixed into the mass at this point by conventional methods.

In a suitable example of a method using scraped-surface cookers, a film of a mixture of the sugar polyol components is spread on a heat exchange surface and heated to about 165-170° C. within a few minutes. The composition is then rapidly cooled to about 100-120° C. and worked as a plastic-like mass, mixing in any optional conventional additives.

In the foregoing methods, the cooking temperature should be sufficiently high to drive water from the mix. Where vacuum is employed, lower temperatures can typically be used. In the foregoing methods, the additive(s) are specifically mixed for a time effective to provide a uniform distribution of the materials, for example about 4 to about 10 minutes. Once the composition has been properly tempered, it can be cut into workable portions or otherwise formed into desired shapes and sizes using forming techniques such as are known in the art.

The foregoing and other embodiments are further illustrated by the following examples, which are not intended to limit the effective scope of the claims. All parts and percentages in the examples and throughout the specification and claims are by weight of the final composition unless otherwise specified.

### EXAMPLES

### Example 1

### Preparation of Particulate Coating Material

The particulate coating composition is prepared by combining the components as set forth in Table 1. The amounts included are based on the weight percent of the total coating composition.

TABLE 1

| Ingredient | A | B | C | D | E | F | G | H |
|---|---|---|---|---|---|---|---|---|
| Powdered | 15-25 | — | 15-25 | — | 15-25 | 15-25 | 50 | 100 |
| Pearlescent | | | | | | | | |
| Pigment | | | | | | | | |
| Flaked Film with | — | 5-10 | — | 5-10 | — | — | — | — |
| pearlescent | | | | | | | | |
| pigment | | | | | | | | |
| Powder | 75-85 | 90-95 | — | — | 75-85 | — | 50 | — |
| Carrier —Talc | | | | | | | | |
| Powder | — | — | 75-85 | 90-95 | — | 75-85 | — | — |
| Carrier— | | | | | | | | |
| Mannitol | | | | | | | | |
| High Intensity | — | — | — | — | 0.001- | 0.001- | — | — |
| Sweetener | | | | | 0.01 | 0.01 | | |

All percentages shown above are percentages by weight of the pigmented coating composition.

To form the pigmented coating composition, the ingredients shown in Table 1 are mixed together using any suitable mixing equipment. Mixing is allowed to proceed until a homogeneous blend is obtained.

### Example 2

### Preparation of Coated Chewing Gum Compositions

Chewing gum core samples are prepared using conventional methods employing the general gum formulation shown in Table 2 below. The formulation of the chewing gum core is not limited and may be any formulation as conceived of by one of skill in the art.

TABLE 2

| | % by weight based on |
|---|---|
| Ingredient | the total composition |
| Gum base | 15-40 |
| Softeners | 1-5 |
| Flavors | 0.1-5 |
| High Intensity Sweetener | 0.1-5 |
| Polyols | 40-60 |

Chewing gum cores are prepared according to the compositions shown in the table above. The chewing gum cores are prepared by first melting the gum base at a temperature of about 60° C. to about 120° C. Once melted and placed in a standard mixer, the remaining ingredients are added and thoroughly mixed for about 1 minute to about 20 minutes. The gum is mixed until completion of the full mixing cycle. The resulting mix is then formed into the desired final shape employing conventional techniques.

The optional step of forming the chewing gum into individual pieces prior to coating may be performed if desired. Alternatively, chewing gum cores may be coated before individual pieces of the chewing gum are formed. Any desired means to form the individual pieces may be used, including, but not limited to extrusion, rolling, scoring, rope cutting, casting, molding, and a combination thereof.

### Pretreatment Using Aqueous Binding Syrups

The aqueous binding syrup(s) is prepared by combining components set forth in Table 3. The amounts are based on weight percent of the total aqueous binding syrup.

TABLE 3
Aqueous Binding Syrup

| | G | H |
|---|---|---|
| Ingredient | | |
| Water | 60 | 80-85 |
| Gum arabic | 40 | — |
| Gelatin | — | 15-20 |
| (250 bloom) | | |

The aqueous binding syrup is prepared by heating the water to at least 35° C., adding the gum arabic or gelatin to the water, and mixing until a homogeneous mixture is formed. The aqueous binding syrup is then applied to the surface of the chewing gum core prepared in Example 2 using any method known in the art including methods such as spraying, panning, enrobing, dipping, tumbling or painting, or combinations thereof. The wetted chewing gum cores are then optionally dried under ambient or drying conditions until the surface of the chewing gum core reaches a desired level of tackiness. The particulate coating compositions prepared in Examples A-G are then applied to the surface of the wetted chewing gum cores using methods known in the art. The resulting coated chewing gum compositions have a pearlescent surface.

### Pretreatment Using Heat

A surface or surfaces of the chewing gum cores prepared in Example 2 are heated to a temperature of about 50° C. The heating can be accomplished using suitable methods known in the art, including the localized heating of surfaces to which the particulate coating composition is to be adhered. The surface of the chewing gum core is heated for a period of time that is sufficient to soften the surface of the chewing gum core without resulting in the deformation of the chewing gum itself.

Following the heating step, a powdered pearlescent pigment (Example H) may be applied directly to the softened surfaces of the chewing gum core. Alternatively, the particulate coating compositions including a powdered carrier as well as a pearlescent pigment, as prepared in Examples A-G, may be applied directly to the softened surface(s).

The singular forms “a,” “an,” and “the” include plural referents unless the context clearly dictates otherwise.

The endpoints of all ranges directed to the same characteristic or component are independently combinable, and inclusive of the recited endpoint.

The word “or” means “and/or.”

Providing may be accomplished by a manufacturer, distributor, or other seller that makes the product available to the consumer.

Reference throughout the specification to “one embodiment”, “other embodiments”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed as the best mode contemplated for carrying out this invention, but that the invention will include

What is claimed is:

1. A particulate coating composition comprising:
a powdered carrier and a pearlescent pigment.

2. The coating composition of claim 1, wherein the weight ratio of powdered carrier to pearlescent pigment is about 40:60 to about 95:5.

3. The coating composition according to claim 1, wherein the pearlescent pigment is present in an amount of about 5% to about 60% by weight of the particulate coating composition

4. The coating composition according to claim 1, wherein the powdered carrier is present in an amount of about 40% to about 95% by weight of the particulate coating composition.

5. The coating composition according to claim 1, wherein the powdered carrier is selected from the group consisting of mannitol, talc, isomalt, polyglycitol, lactitol, erythritol, sucrose and combinations thereof.

6. The coating composition according to claim 1, wherein the powdered carrier is talc or mannitol.

7. The coating composition according claim 1, wherein the average particle size of the pearlescent pigment is about 10 μm to about 250 μm.

8. The coating composition according to claim 1, wherein the pearlescent pigment comprises titanium dioxide deposited on mica platelets.

9. The coating composition according to claim 1, wherein the average particle size of the powdered carrier is about 0.5 μm to about 500 μm.

10. A coated chewing gum composition comprising
a gum core comprising a gum base, and
a particulate coating composition at least partially surrounding the gum core;
wherein the particulate coating composition comprises a powdered carrier and a pearlescent pigment.

11. The coated chewing gum of claim 10, wherein the powdered carrier is selected from the group consisting of talc, mannitol, isomalt, polyglycitol, lactitol, erythritol, sucrose and combinations thereof.

12. The coated chewing gum according to claim 10, wherein the pearlescent pigment is present in the particulate coating composition in an amount of about 5% to about 60% by weight of the particulate coating composition.

13. The coated chewing gum according to claim 10, wherein the powdered carrier is present in the particulate coating composition in an amount of about 40% to about 95% by weight of the particulate coating composition.

14. The coated chewing gum according to claim 10, wherein the amount of particulate coating on the gum core is about 0.5% to about 15% by weight based on the total weight of the coated chewing gum composition.

15. The coated chewing gum according to claim 10, wherein the amount of pearlescent pigment is about 0.01% to about 5% by weight of the chewing gum composition.

16. The coated chewing gum according to claim 10, wherein the wherein the weight ratio of powdered carrier to pearlescent pigment is about 40:60 to about 95:5.

17. The coated chewing gum according to claim 10, wherein the particulate coating composition further comprises a food acid or salt thereof, an additional sweetener, a sensate, a flavorant, a flavor modulator or potentiator, a coloring agent, a functional ingredient, or a combination thereof.

18. The coated chewing gum composition according to claim 10, wherein the pearlescent pigment is a particulate pearlescent pigment or a film comprising the particulate pearlescent pigment.

19. The coated chewing gum composition according to claim 10, wherein the average particle size of the pearlescent pigment is about 10 μm to about 250 μm.

20. The coated chewing gum according to claim 10, wherein the chewing gum further comprises a binding layer disposed between the gum core and the particulate coating composition.

21. The coated chewing gum according to claim 20, wherein the binding layer comprises gum arabic, gelatin, a cellulose, a starch, a sugar polyol, a saccharide, gelatin or a combination thereof.

22. The coated chewing gum according to claim 20, wherein the binding layer comprises fats, waxes, liquid oils or a combination thereof.

23. A method of making a coated chewing gum composition, comprising:
applying a particulate coating composition to at least one surface of a chewing gum core to form a coated chewing gum core,
wherein the particulate coating composition comprises a pearlescent pigment.

24. The method of claim 23, wherein the method further comprises applying an aqueous binding liquid, a non-aqueous binding liquid or a combination thereof to the at least one surface of the chewing gum core prior to applying the particulate coating composition.

25. The method according to claim 24, wherein the aqueous binding liquid is a binding syrup comprising gum arabic, a cellulose, a starch, a sugar polyol, a saccharide, gelatin or a combination thereof.

26. The method according to claim 24, wherein the non-aqueous binding liquid comprises fats, waxes, liquid oils or a combination thereof.

27. The method according to claim 23, wherein the method further comprises heating the at least one surface of the chewing gum core prior to applying the particulate coating composition.

28. The method according to claim 23, wherein the at least one surface of the chewing gum core is heated to a temperature of about 35° C. to about 50° C.

29. The method according to claim 23, wherein the particulate coating composition further comprises a powdered carrier.

30. The method according to claim 29, wherein the powdered carrier is selected from the group consisting of talc, mannitol, isomalt, polyglycitol, lactitol, erythritol, sucrose and combinations thereof.

31. The method according to claim 23, further comprising forming the chewing gum core into individual chewing gum pieces.

32. The method according to claim 23, wherein the particulate coating composition is applied to the at least one surface of the chewing gum core before individual pieces of the chewing gum are formed.

33. The method according to claim 23, wherein the particulate coating composition is applied to the at least one surface of the chewing gum core after individual pieces of the chewing gum are formed.
